(19) United States
(12) Patent Application Publication
(10) Pub. No.: US 2020/0049833 A1
(43) Pub. Date: Feb. 13, 2020

(54) METHOD FOR CONVERTING A GNSS RECEIVING SYSTEM HAVING NO INTERFERENCE PROTECTION INTO A CRPA RECEIVING SYSTEM AND CRPA SYSTEM

(71) Applicant: DIEHL DEFENCE GMBH & CO. KG, Ueberlingen (DE)

(72) Inventors: CLEMENS DRUMMER, FORCHHEIM (DE); ROBERT BURKHARDT, LAUF (DE)

(21) Appl. No.: 16/530,608

(22) Filed: Aug. 2, 2019

(30) Foreign Application Priority Data
Aug. 7, 2018 (DE) 102018006225.3

(51) Int. Cl. G01S 19/21; G01S 19/36

(52) U.S. Cl. CPC G01S 19/21; G01S 19/215; G01S 19/36

(57) ABSTRACT

A method converts a GNSS receiving system having no interference protection into an interference-suppressing CRPA receiving system. To achieve a low-effort conversion, it is proposed that an existing GNSS antenna is replaced with a CRPA antenna having a CRPA interference suppression unit and the CRPA interference suppression unit is connected to a GNSS receiver by a coaxial cable. A control unit is connected to the coaxial cable, the control unit uses the coaxial cable to conduct a bidirectional communication with the CRPA interference suppression unit. A GNSS signal is received using the CRPA antenna and has interference suppressed using the CRPA interference suppression unit, and the interference-suppressed signal is routed to the GNSS receiver by the coaxial cable.

### CROSS-REFERENCE TO RELATED APPLICATION

This application claims the priority, under 35 U.S.C. § 119, of German application DE 10 2018 006 225.3, filed Aug. 7, 2018; the prior application is herewith incorporated by reference in its entirety.

### BACKGROUND OF THE INVENTION

### FIELD OF THE INVENTION

The invention relates to a method for converting a GNSS receiving system having no interference protection into a CRPA receiving system, in which an existing GNSS antenna is replaced with a CRPA antenna having a CRPA computation unit.

Vehicles on land, on water and in the air use the global navigation satellite system (GNSS) to determine their own position. Depending on the country of origin of the vehicle, national and regional systems can be used, such as the system NAVSTAR GPS of the United States of America, GLONASS of the Russian Federation, Galileo of the European Union or Beidou of the People's Republic of China. Signal propagation times of signals of multiple satellites are used to ascertain a vehicle's own position and to navigate the vehicle.

In the military sector, in particular, systems exist for electronic countermeasures intended to hamper the navigation of approaching vehicles. As such, for example what is known as noise jamming at the frequency of GNSS satellites is used to send white noise at a very high level in which the actual satellite system drowns. The signal-to-noise ratio of the receiver is so poor that it is no longer able to receive the original satellite signal. A further method is what is known as spoofing, which involves interference signals that feign false positions being sent on the frequency of the satellite signals.

To protect against electronic measures of this kind, what are known as controlled radiation pattern antenna (CRPA) antennas are used. A CRPA antenna contains multiple single antennas that can be used to ascertain the direction of the arriving signals. Since interference signals usually do not come from the same direction as the original satellite signals, they can be rejected by deliberately masking out reception directions calculated in this manner to such an extent that the original satellite signal from the satellite direction continues to be receivable and evaluable. To maintain the navigation capability, it is therefore advantageous to convert a vehicle with a GNSS receiving system having no interference protection using a CRPA receiving system.

### SUMMARY OF THE INVENTION

It is an object of the invention to specify a method for converting a GNSS receiving system having no interference protection into a CRPA receiving system that can be performed with relatively little effort.

This object is achieved by a method of the type set out at the outset, in which an existing GNSS antenna is replaced with a CRPA antenna having a CRPA interference suppression unit and the CRPA interference suppression unit is connected to a GNSS receiver, which can be the receiver of the original system having no interference protection, by means of an existing coaxial cable. The coaxial cable likewise has a control unit connected to it that can use the coaxial cable to conduct a bidirectional communication with the CRPA interference suppression unit. A GNSS signal can then be received using the CRPA antenna and have interference suppressed using the CRPA interference suppression unit. The interference-suppressed signal can be routed to the GNSS receiver by a coaxial cable. The interference-suppressed signal can then be used by the GNSS receiver to determine the position of the system, which for example is part of a vehicle, such as a land vehicle, an aircraft or a watercraft.

The invention is based on the consideration that in existing GNSS receiving systems the GNSS antenna and the GNSS receiver have a coaxial cable between them by means of which the antenna signals are provided to the GNSS receiver for the purpose of calculating the position. If interference suppression for the GNSS signal is now intended to take place, then it is advantageous for the CRPA interference suppression unit performing such interference suppression to have control signals or other digital data transmitted to it that improve the interference suppression or make it possible in the first place. To this end, a data cable via which the digital data traffic runs can be laid between control unit and CRPA interference suppression unit.

To retrofit or convert a vehicle with a CRPA (Controlled Radiation Pattern Antenna) receiving system, the additional data cable needs to be laid in interference-free fashion. For use on a ship on which the CRPA antenna is arranged on a mast in an exposed location, the data cable needs to be provided with lightning protection. This is sophisticated, depending on the length of the section at risk. In the case of a land vehicle, it may be necessary to route the additional data cable through a bodywork element that has to be weakened by an additional opening through it and re-approved. This effort is also disadvantageous.

These disadvantages can be overcome by virtue of the data traffic between CRPA interference suppression unit and control unit being carried in combination with the GNSS signal traffic. A cable retrofit can be dispensed with. To this end, control unit and CRPA interference suppression unit are connected to the coaxial cable, for example by means of one signal separating network each, and both units communicate with one another by means of the coaxial cable.

The CRPA receiving system is usefully prepared to perform detection of the position of the system or of the vehicle in which the system may be located. A land vehicle, a watercraft or an aircraft is suitable, the latter also being able to be understood below to mean unmanned aerial vehicles. The CRPA receiving system is equipped with a CRPA antenna having multiple antennas that are each embodied to receive GNSS signals. GNSS signals received by the CRPA antenna are forwarded to the CRPA interference suppression unit directly or after signal processing that suppresses interference with the signals. This is done in a CRPA interference suppression unit by at least largely removing direction-specific signals. The multiple antennas can detect GNSS signals, that is to say satellite signals or a combination of satellite signals and interference signals, on the basis of their direction of incidence. One or more directions of incidence can then be deliberately blocked. The direction can be chosen in this case such that it points to the interference transmitter. The signals thereof are then rejected or at least substantially removed from the overall signal by a computation algorithm. What are left are evaluable satellite signals from which the position of the system or of the vehicle can be calculated. The removal of the interference signal at least largely from the overall signal can be effected by a computer.

The GNSS receiving system existing before the conversion has no interference protection, which in this context can be understood to mean that it has no protection against jamming and/or spoofing. When a jammer is present or when a satellite signal is covered by a jammer, the satellite signal can no longer be detected and the position of the system cannot be ascertained.

The control unit is prepared to control the CRPA interference suppression unit, for example to load new software, in particular new firmware, onto the CRPA interference suppression unit. Retrieval of data, for example a reception spectrum of the CRPA antenna, is also advantageous.

In an advantageous embodiment of the invention, the CRPA interference suppression unit is supplied with operating voltage by the coaxial cable. In this manner, the coaxial cable can be used not only for signal data and control data, but also for supplying power to the CRPA interference suppression unit.

To interfere with the reception of GNSS signals from satellites, there is a multiplicity of possible jamming modulations. These are normally known and appropriate interference suppression algorithms are stored in the CRPA interference suppression unit for suppressing interference for the received signals. However, it can arise that a new interference method is used against which the CRPA interference suppression unit contains no algorithm. The received GNSS signal then needs to be examined for an applicable modulation and a suitable interference suppression algorithm needs to be produced. Depending on the interference method, this can require hours or days. The new interference suppression algorithm can then be loaded onto the CRPA interference suppression unit as firmware. In this respect, in a further refinement of the invention, it is advantageous if the control unit uses the coaxial cable to load software, in particular firmware, onto the CRPA interference suppression unit. The firmware can contain, inter alia, a software update for the CRPA interference suppression unit, which can also be understood to mean a new interference suppression algorithm.

To control the interference suppression and/or in order to obtain an overview of jammers that are at hand, it is advantageous if the CRPA interference suppression unit requests the signal spectrum received by the CRPA antenna. This can be displayed graphically, for example, to an operator, such as signal strengths on the basis of signal frequencies, so that the interference can be visually detected and evaluated. In this respect, it is advantageous if the control unit uses the coaxial cable to request a reception spectrum of the CRPA antenna and the reception spectrum is sent from the CRPA interference suppression unit to the control unit by use of the coaxial cable. All of the data traffic can be handled by the coaxial cable as a result, so that a high bandwidth of control mechanisms can be handled without using an additional data cable.

Furthermore, it makes sense to send data for switching on and shutting down the CRPA interference suppression unit or a function of the CRPA interference suppression unit from the control unit to the CRPA interference suppression unit by the coaxial cable. If for example a jamming level is so high that the interference suppression electronics cannot process the signal, or there is even a threat of the electronics sustaining damage, then the CRPA interference suppression unit as a whole can be shut down, or just one function thereof is switched on or shut down, such as for example a filter function.

Additionally, it makes sense if the control unit sends a level strength change command to the CRPA interference suppression unit by the coaxial cable. If for example the signal forwarded to the GNSS receiver is too strong or too weak, an appropriate level change can provide a signal processable by the receiving unit to the receiving unit.

Overall, it is advantageous if both the CRPA interference suppression unit and the control unit use the coaxial cable to conduct a bidirectional communication. It is beneficial to effective programming of the control unit and/or of the CRPA interference suppression unit if one, usefully both, of these units contain(s) an FPGA (Field Programmable Gate Array). In this case, the bidirectional communication can be conducted by the coaxial cable between these two FPGAs.

A particularly advantageous application for the invention is application in a seagoing vessel domain, wherein the CRPA antenna is arranged on a ship's mast. The coaxial cable in this case can stretch from the ship's mast to a data processing room, wherein the CRPA interference suppression unit can likewise be arranged on the ship's mast and the control unit can be arranged in the data processing room. The bidirectional communication between these units can consequently be managed over long distances on the seagoing vessel in a simple manner, without additional and very long lightning protection needing to be installed for a data cable.

The invention is additionally directed to a method for suppressing interference for a GNSS signal using a CRPA interference suppression unit. Such a method can be performed for example after the GNSS receiving system that had no interference protection beforehand is converted into the interference-suppressing CRPA receiving system. This method involves the control unit using a coaxial cable to conduct a bidirectional communication with the CRPA interference suppression unit. The GNSS signal is received using a CRPA antenna and has interference suppressed using the CRPA interference suppression unit, and the interference-suppressed signal is routed to a GNSS receiver by means of the coaxial cable. In the GNSS receiver, the signal can be evaluated and the signal can be used to perform position determination. This method is also performable with one, multiple or all detail(s) of the method described above.

The invention is likewise directed to a CRPA receiving system having a CRPA antenna for receiving a GNSS signal, a CRPA interference suppression unit for suppressing interference for the GNSS signal, a GNSS receiver and a coaxial cable between the CRPA interference suppression unit and the GNSS receiver. To easily retrofit a vehicle with the CRPA receiving system, it is proposed that the latter has a control unit that is connected to the CRPA interference suppression unit by the coaxial cable and is prepared for a bidirectional communication with the CRPA interference suppression unit by the coaxial cable.

The description of advantageous refinements of the invention that has been provided hitherto contains numerous features, some of which are reproduced in combination with one another in some dependent claims. The features can usefully also be considered individually and combined to produce worthwhile further combinations, in particular in the case of back-references from claims, however, so that a single feature of one dependent claim is combinable with a single, multiple or all feature(s) of another dependent claim. Additionally, these features are each individually, and in any suitable combination, combinable both with the method according to the invention and with the apparatus according to the invention according to the independent claims. As such, method features should also be considered to be worded substantively as properties of the corresponding apparatus unit, and functional apparatus features should also be considered to be substantively worded as corresponding method features.

The properties, features and advantages of this invention that are described above and the way in which they are achieved will become clearer and more clearly understood in association with the description of the exemplary embodiments that follows, the exemplary embodiments being explained in greater detail in association with the drawings. The exemplary embodiments are used to explain the invention and do not restrict the invention to the combination of features that is indicated therein, not even with regard to functional features. Additionally, features of each exemplary embodiment that are suitable therefor can also explicitly be considered in isolation, be removed from an exemplary embodiment, be introduced into another exemplary embodiment in order to supplement the latter and/or be combined with any one of the claims.

Other features which are considered as characteristic for the invention are set forth in the appended claims.

Although the invention is illustrated and described herein as embodied in a method for converting a GNSS receiving system having no interference protection into a CRPA receiving system, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a block diagram of a CRPA receiving system having a multi-antenna arrangement, a CRPA interference suppression unit and a control unit, according to the invention;

FIG. 2 is a block diagram showing the control unit from FIG. 1; and

FIG. 3 is a block diagram showing a signal separating network from the control unit.

### DETAILED DESCRIPTION OF THE INVENTION

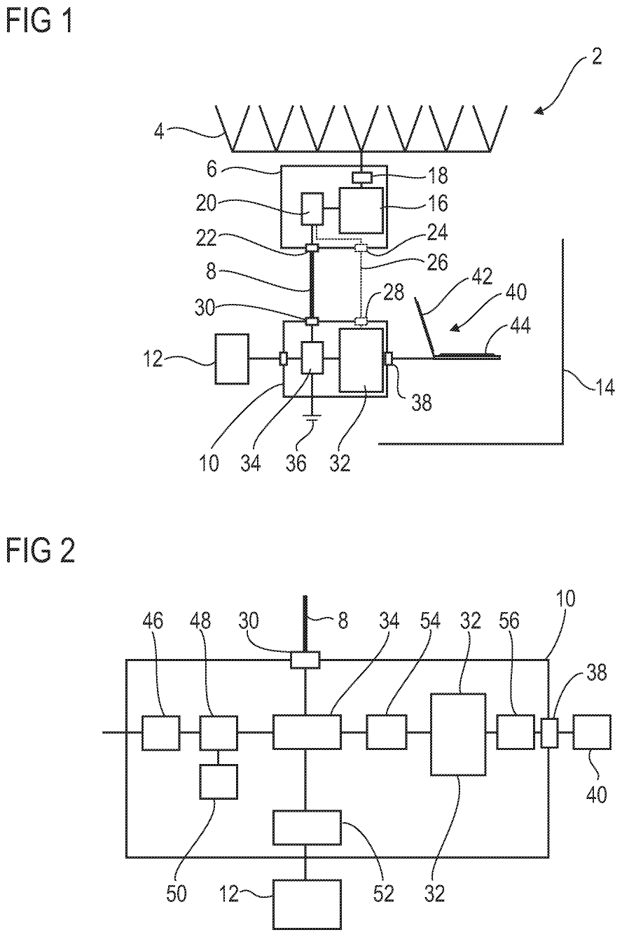

Referring now to the figures of the drawings in detail and first, particularly to FIG. 1 thereof, there is shown a CRPA receiving system 2 in a schematic block diagram depiction with an arrangement containing multiple GNSS antennas 4. In this exemplary embodiment, there are seven GNSS antennas 4 at hand, all of which, in their arrangement in relation to one another, form a CRPA antenna. Connected to the antennas 4 for signalling purposes is a CRPA interference suppression unit 6 connected to a control unit 10 by a coaxial cable 8. A GNSS receiver 12 is used to determine GNSS data from the GNSS antenna 4 in location information or position information for the system 2 or for a vehicle 14 within which the CRPA receiving system 2 is arranged.

The vehicle 14 can be a land vehicle, a watercraft or an aircraft and is indicated only schematically in FIG. 1. The GNSS antennas 4 are in a physical arrangement in relation to one another such that they can receive incident GNSS signals, which can also have jamming interference, spoofing interference or other interference contained inside them, in spatially resolved fashion. Their GNSS signals are routed to the CRPA interference suppression unit 6, which suppresses interference with the signals and forwards them in interference-suppressed form to the control unit 10 by the coaxial cable 8. To this end, the CRPA interference suppression unit 6 contains an FPGA 16 that receives the GNSS signals from the antennas 4 by input electronics 18 of the GNSS antennas 4. The FPGA 16 spatially breaks down the signals and filters out the jamming component by rejecting the applicable reception direction, so that a largely interference-free GNSS signal or a GNSS signal that is evaluable at least in respect of the position information contained is output.

The FPGA 16 provides its output signal to a signal separating network 20 that forwards the signal to the coaxial cable 8 by an interface 22. The signal separating network 20 can also be used to forward the signal in digital form to the control unit 10 or another suitable unit by a further interface 24 and a data cable 26. This can be worthwhile for a laboratory operation, for example, if an applicable control unit or an evaluation device contains an additional interface 28 by which it communicates with the CRPA interference suppression unit 6 bidirectionally using digital control data.

In the usual case of operation, the data cable 26 and the interfaces 24, 28 can be dispensed with, wherein the control data are also routed via the coaxial cable 8 connected to the CRPA interference suppression unit or the control unit 10 by means of the interfaces 22, 30. In order to show that the CRPA receiving system 2 is also operational with the single-cable solution alone and the data cable 26 is only optional, the relevant components are depicted in dashes in FIG. 1.

The control unit 10 likewise contains an FPGA 32 connected to the interface 30 or to the coaxial cable 8 by a signal separating network 34. In the signal separating network 34, the control signals with the control data from and to the FPGA 32 are separated from the GNSS signals forwarded to the GNSS receiver. Additionally, an operating voltage provided by a power supply 36 is likewise put onto the coaxial cable 8, so that it is used to supply the CRPA interference suppression unit 6 and the CRPA antenna 4 with power. An interface 38 can be used to perform a bidirectional data traffic with an operating unit 40 containing for example a display unit 42 and an input unit 44, so that an operator can view graphical information on the display unit 42 and can give commands to the control unit 10 via the input unit 44.

The control unit 10 is shown in a more detailed block diagram in FIG. 2. The interface 30 connects the coaxial cable 8 to the signal separating network 34, which is a DC separating network. The power supply is routed to a DC/DC converter 48 via an EMC filter 46. Optionally, there may be a regulator 50 at hand for drivers and amplifiers. The signal separating network 34 is used to supply the DC current to the coaxial cable 8 as a power supply.

The GNSS signal is routed from the signal separating network 34 via an optional attenuation element 52 to the GNSS receiver 12, where the signal is converted into position information. The control data are carried between the signal separating network 34 and the FPGA 32 by a bidirectional changeover switch 54, which uses the TDMA method and converts the bidirectional data traffic into a monodirectional block traffic first in one and then in the other direction, for example. To output information from the FPGA 32 to the operating unit 40, an EMC filter 56 protects the data traffic.

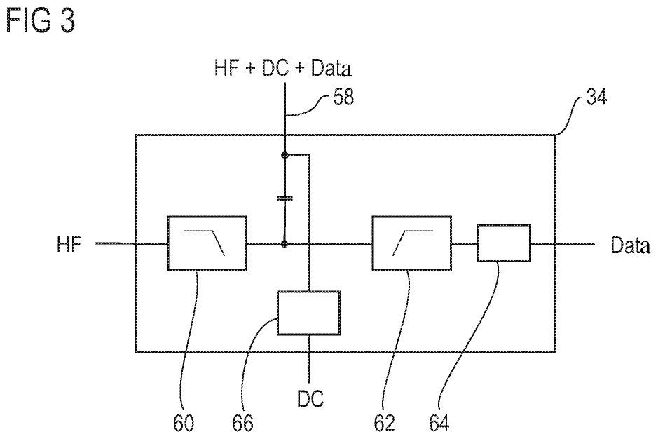

FIG. 3 shows the signal separating network 34 in a more detailed block diagram. The direction toward the coaxial cable 8 is denoted by the reference sign 58. This data connection—and also the coaxial cable 8—contains the radio-frequency signal together with the control data and the DC supply. The radio-frequency signal, that is to say the GNSS data, is provided to the GNSS receiver 12 by a high-pass filter 60. A low-pass filter 62 and an optional DC block 64 are used to provide the control data in the direction of the FPGA 32. Also, there is a DC filter 66 upstream of the DC access.

Usual vehicles contain a GNSS antenna 4 connected to the GNSS receiver 12 by means of the coaxial cable 8. To convert such a GNSS receiving system having no interference protection to a CRPA receiving system 2, the existing GNSS antenna 4 can be replaced with the CRPA antenna 4. The CRPA interference suppression unit 6 is inserted between antenna 4 and coaxial cable 8. At the other end of the coaxial cable 8, the control unit 10 is connected upstream of the GNSS receiver 12. The coaxial cable 8 running from the location of the antenna 4 to the location of the GNSS receiver 12 can substantially remain in its place, so that conversion of the vehicle is associated with very little effort.

To operate the CRPA receiving system 2, the control unit 10 can actuate the CRPA interference suppression unit 6 and/or supply it with software, in particular firmware. Operation can be switched on and off and operating data, in particular received data, can be requested from the CRPA interference suppression unit 6 by the control unit 10 and provided to the operating unit 40, for example. The latter can also be used to initialize the CRPA interference suppression unit 6. After the CRPA interference suppression unit 6 is supplied with the necessary software and with control signals necessary for operation, the GNSS signal, which can contain jamming signals and/or spoofing signals, has interference suppressed by the CRPA interference suppression unit 6, so that the output interference-suppressed GNSS signal can be processed by the GNSS receiver 12 to produce position information. Control data, information data and operating data are routed from the CRPA interference suppression unit 6 to the control unit 10 by the coaxial cable 8 and forwarded, for example in parts, to the operating unit 40.

The following is a summary list of reference numerals and the corresponding structure used in the above description of the invention:
2 CRPA receiving system
4 GNSS antenna
6 CRPA interference suppression unit
8 Coaxial cable
10 Control unit
12 GNSS receiver
14 Vehicle
16 FPGA
18 Input electronics
20 Signal separating network
22 Interface
24 Interface
26 Data cable
28 Interface
30 Interface
32 FPGA
34 Signal separating network
36 Power supply
38 Interface
40 Operating unit
42 Display unit
44 Input unit
46 EMC filter
48 DC/DC converter
50 Regulator
52 Attenuation element
54 Changeover switch
56 EMC filter
58 Data direction
60 HP filter
62 LP filter
64 DC block
66 DC filter

1. A method for converting a global navigation satellite system (GNSS) receiving system having no interference protection into an interference-suppressing controlled radiation pattern antenna (CRPA) receiving system, which comprises the steps of:
replacing an existing GNSS antenna with a CRPA antenna having a CRPA interference suppression unit;
connecting the CRPA interference suppression unit to a GNSS receiver by an existing coaxial cable, and a controller is connected to the coaxial cable, the controller uses the coaxial cable to conduct a bidirectional communication with the CRPA interference suppression unit;
receiving a GNSS signal is received using the CRPA antenna and has interference suppressed using the CRPA interference suppression unit; and
routing an interference-suppressed signal to the GNSS receiver by the coaxial cable.

2. The method according to claim 1, which further comprises supplying the CRPA interference suppression unit with an operating voltage by means of the coaxial cable.

3. The method according to claim 1, wherein the controller uses the coaxial cable to load firmware onto the CRPA interference suppression unit.

4. The method according to claim 1, wherein the controller uses the coaxial cable to request a reception spectrum of the CRPA antenna, and the reception spectrum is sent from the CRPA interference suppression unit to the controller by means of the coaxial cable.

5. The method according to claim 1, which further comprises sending, via the controller, a command for shutting down a filter function of the CRPA interference suppression unit to the CRPA interference suppression unit by means of the coaxial cable.

6. The method according to claim 1, which further comprises sending, via the controller, a level strength change command to the CRPA interference suppression unit by means of the coaxial cable.

7. The method according to claim 1, wherein both the CRPA interference suppression unit and the controller contain a field-programmable gate array (FPGA) and the bidirectional communication is conducted between the FPGAs by means of the coaxial cable.

8. The method according to claim 1, wherein the coaxial cable runs from a ship's mast to a data processing room of a seagoing vessel.

9. An operating method, which comprises the steps of:
suppressing interference of a global navigation satellite system (GNSS) signal by using a controlled radiation pattern antenna (CRPA) interference suppression unit;
conducting bidirectional communication between the CRPA interference suppression unit and a controller using a coaxial cable;
receiving the GNSS signal using a CRPA antenna and the interference being suppressed using the CRPA interference suppression unit; and
routing an interference-suppressed signal to a GNSS receiver by means of the coaxial cable.

10. A controlled radiation pattern antenna (CRPA) system, comprising:
a receiving system having a CRPA antenna for receiving a global navigation satellite system (GNSS) signal;
a CRPA interference suppression unit for suppressing interference of the GNSS signal;
a GNSS receiver;
a coaxial cable connected between said CRPA interference suppression unit and said GNSS receiver; and
a controller connected to said CRPA interference suppression unit by means of said coaxial cable and is prepared for a bidirectional communication with said CRPA interference suppression unit by means of said coaxial cable.
